(19) United States
(12) Patent Application Publication
(10) Pub. No.: US 2012/0105905 A1
(43) Pub. Date: May 3, 2012

(54) System and Method for Operation of Document Processing Devices Via Portable Data Devices

(75) Inventors: Hongfeng Wei, Cerritos, CA (US); Jianxin Wang, Trabuco Canyon, CA (US); William Su, Riverside, CA (US); Sheng Lee, Irvine, CA (US)

(73) Assignees: Toshiba Tec Kabushiki Kaisha, Shinagawa-ku (JP); Kabushiki Kaisha Toshiba, Minato-ku (JP)

(21) Appl. No.: 12/916,424

(22) Filed: Oct. 29, 2010

(51) Int. Cl. G06F 3/12

(52) U.S. Cl. 358/1.15

(57) ABSTRACT

The subject application is directed to a system and method for operation of document processing devices via portable data devices. A wireless data connection is established between a document processing device including a processor and associated data storage and an associated mobile data device. A remote installation of a software interface for the document processing device is initiated on the mobile data device via the wireless data connection. A multicast probe is received via the wireless data connection from the mobile data device initiated in accordance with operation of the software interface after installation. The mobile data device is registered with the document processing device in accordance with a response to the multicast probe. Control data generated by the software interface operable to commence at least one document processing operation on the document processing device is received from the mobile data device via the wireless data connection.

### BACKGROUND OF THE INVENTION

The subject application is directed generally to operation of document processing device operations via portable data devices. The application is particularly applicable to completion of scan, storage, retrieval, or printing operations via a user operating a portable data device.

Document processing devices include copiers, printers, facsimile machines, scanners, or e-mail gateways. More recently, devices include two or more of these functions, and are referred to as multifunction peripherals (MFPs) or multifunction devices (MFDs). Devices, such MFPs, are frequently integrated into data networks, allowing them to communicate electronic data with workstations, other MFPs, or servers.

Users may access document processing devices by walking up to a device, and operating it via a user interface, such as an integrated touch-screen panel. Alternatively, a user may access a document processing device via a workstation that is in networked data communication with the device. A user can send electronic documents to a device for printing, e-mailing, storage, or faxing.

More recently, users frequently use mobile data devices, such notebook computers, personal digital assistants (PDAs), smart phones, or electronic book readers, rather than exclusively relying on networked workstations.

### SUMMARY OF THE INVENTION

In accordance with one embodiment of the subject application, there is provided a system and method for operation of document processing devices via portable data devices. A wireless data connection is established between a document processing device including a processor and associated data storage and an associated mobile data device. A remote installation of a software interface for the document processing device is initiated on the mobile data device via the wireless data connection. A multicast probe is received via the wireless data connection from the mobile data device initiated in accordance with operation of the software interface after installation thereon. The mobile data device is registered with the document processing device in accordance with a response to the multicast probe. Control data generated by the software interface operable to commence at least one document processing operation on the document processing device is received from the mobile data device via the wireless data connection.

Still other advantages, aspects and features of the subject application will become readily apparent to those skilled in the art from the following description wherein there is shown and described a preferred embodiment of the subject application, simply by way of illustration of one of the best modes best suited to carry out the subject application. As it will be realized, the subject application is capable of other different embodiments and its several details are capable of modifications in various obvious aspects all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of a system for operation of document processing devices via portable data devices according to one embodiment of the subject application;

FIG. 2 is a block diagram illustrating device hardware for use in the system for operation of document processing devices via portable data devices according to one embodiment of the subject application;

FIG. 3 is a functional diagram illustrating the device for use in the system for operation of document processing devices via portable data devices according to one embodiment of the subject application;

FIG. 4 is a block diagram illustrating controller hardware for use in the system for operation of document processing devices via portable data devices according to one embodiment of the subject application;

FIG. 5 is a functional diagram illustrating the controller for use in the system for operation of document processing devices via portable data devices according to one embodiment of the subject application;

FIG. 6 is a block diagram illustrating a workstation for operation of document processing devices via portable data devices according to one embodiment of the subject application;

FIG. 7 is a block diagram illustrating a server for operation of document processing devices via portable data devices according to one embodiment of the subject application;

FIG. 8 is a block diagram illustrating the system for operation of document processing devices via portable data devices according to one embodiment of the subject application;

FIG. 9 is a functional diagram illustrating the system for operation of document processing devices via portable data devices according to one embodiment of the subject application;

FIG. 10 is a flowchart illustrating a method for operation of document processing devices via portable data devices according to one embodiment of the subject application;

FIG. 11 is a flowchart illustrating a method for operation of document processing devices via portable data devices according to one embodiment of the subject application;

FIG. 12 is a flowchart illustrating an example discovery of document processing devices by a portable device based upon the method for operation of document processing devices via portable data devices according to one embodiment of the subject application;

FIG. 13 is a flowchart illustrating an example use of document processing devices by a portable device based upon the method for operation of document processing devices via portable data devices according to one embodiment of the subject application; and

FIG. 14 is a flowchart illustrating another example use of document processing devices by a portable device based upon the method for operation of document processing devices via portable data devices according to one embodiment of the subject application.

### DETAILED DESCRIPTION OF THE PREFERRED EMBODIMENT

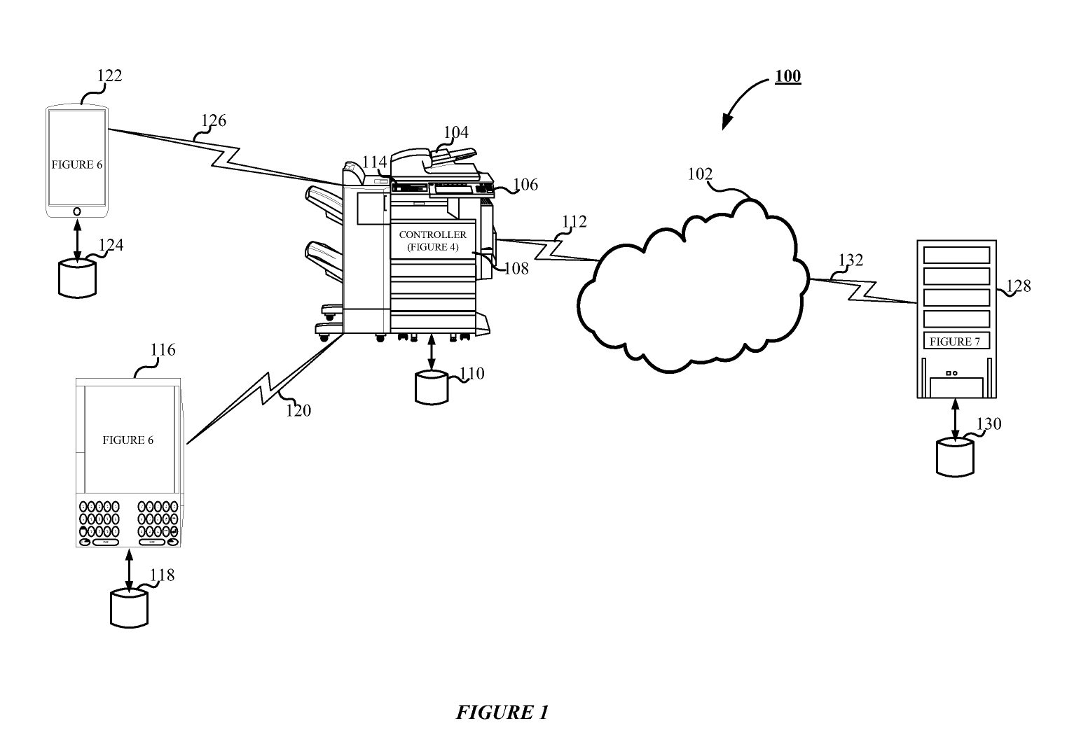

The subject application is directed to a system and method for operation of document processing devices via portable data devices. More particularly, the application is directed to completion of scan, storage, retrieval, or printing operations via a user operating a portable data device. It will become apparent to those skilled in the art that the system and method described herein are suitably adapted to a plurality of varying electronic fields employing portable telecommunication devices, including, for example and without limitation, communications, general computing, data processing, document processing, or the like. The preferred embodiment, as depicted in FIG. 1, illustrates a document processing field for example purposes only and is not a limitation of the subject application solely to such a field.

Referring now to FIG. 1, there is shown an overall diagram of a type of system 100 for operation of document processing devices via portable data devices in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or any suitable combination thereof. In accordance with the preferred embodiment of the subject application, the computer network 102 is comprised of physical layers and transport layers, as illustrated by the myriad of conventional data transport mechanisms, such as, for example and without limitation, Token-Ring, 802.11(x), Ethernet, or other wireless or wire-based data communication mechanisms. The skilled artisan will appreciate that while a computer network 102 is shown in FIG. 1, the subject application is equally capable of use in a stand-alone system, as will be known in the art.

The system 100 also includes a document processing device 104, which is depicted in FIG. 1 as a multifunction peripheral device, suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially available document processing devices include, for example and without limitation, the Toshiba e-Studio Series Controller. In accordance with one aspect of the subject application, the document processing device 104 is suitably adapted to provide remote document processing services to external or network devices. Preferably, the document processing device 104 includes hardware, software, and any suitable combination thereof, configured to interact with an associated user, a networked device, or the like.

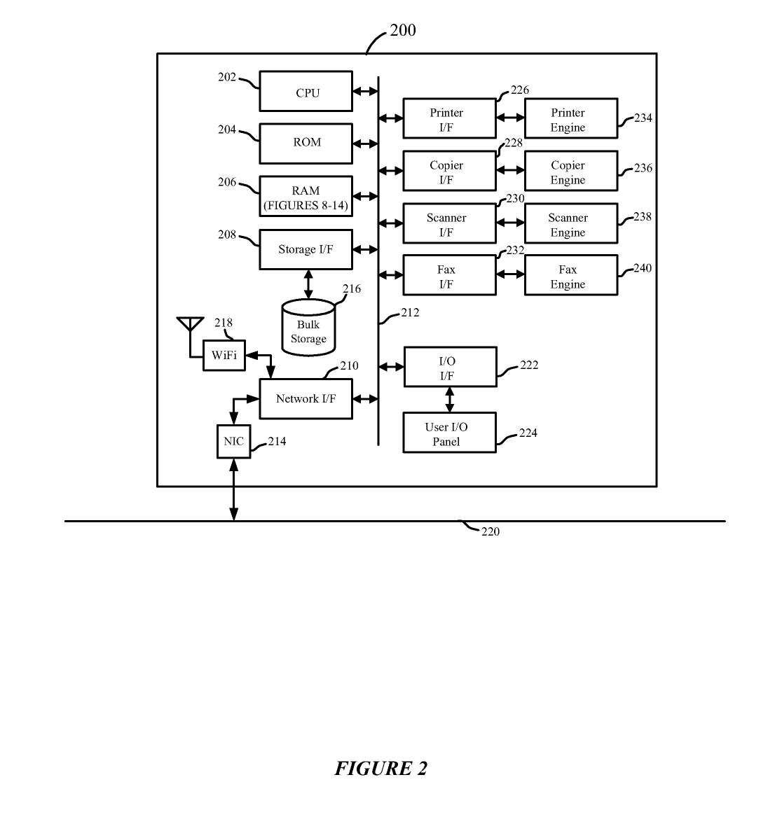

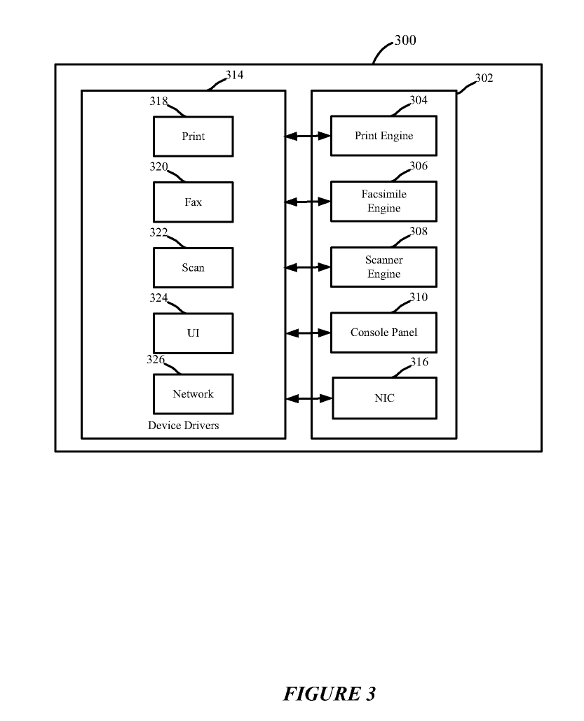

According to one embodiment of the subject application, the document processing device 104 is suitably equipped to receive a plurality of portable storage media, including, without limitation, Firewire drive, USB drive, SD, MMC, XD, Compact Flash, Memory Stick, and the like. In the preferred embodiment of the subject application, the document processing device 104 further includes an associated user interface 106, such as a touchscreen, LCD display, touch-panel, alpha-numeric keypad, or the like, via which an associated user is able to interact directly with the document processing device 104. In accordance with the preferred embodiment of the subject application, the user interface 106 is advantageously used to communicate information to the associated user and receive selections from the associated user. The skilled artisan will appreciate that the user interface 106 comprises various components, suitably adapted to present data to the associated user, as are known in the art. In accordance with one embodiment of the subject application, the user interface 106 comprises a display, suitably adapted to display one or more graphical elements, text data, images, or the like, to an associated user, receive input from the associated user, and communicate the same to a backend component, such as the controller 108, as explained in greater detail below. Preferably, the document processing device 104 is communicatively coupled to the computer network 102 via a communications link 112. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art. The functioning of the document processing device 104 will be better understood in conjunction with the block diagrams illustrated in FIGS. 2 and 3, explained in greater detail below.

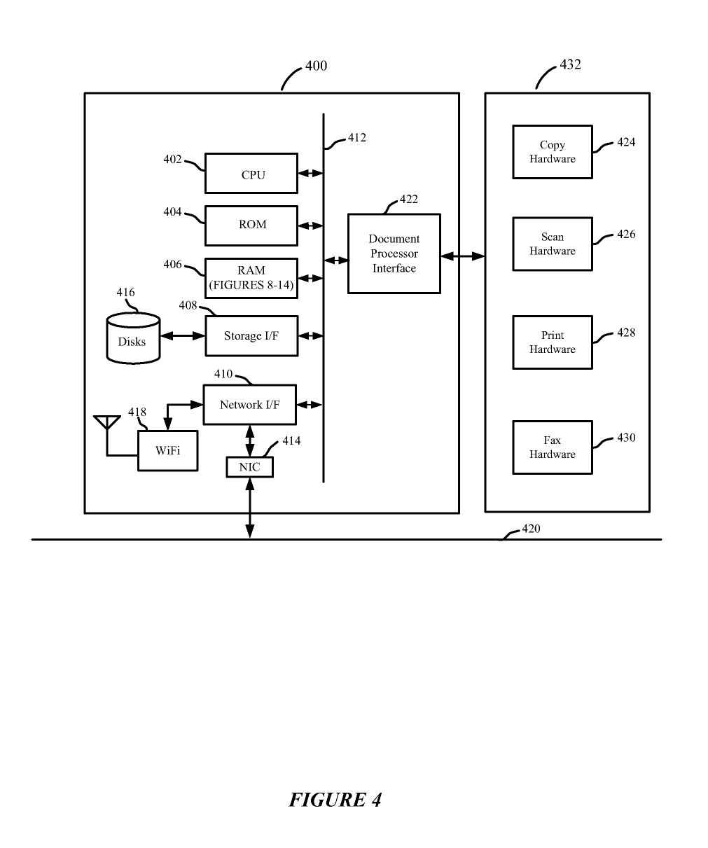

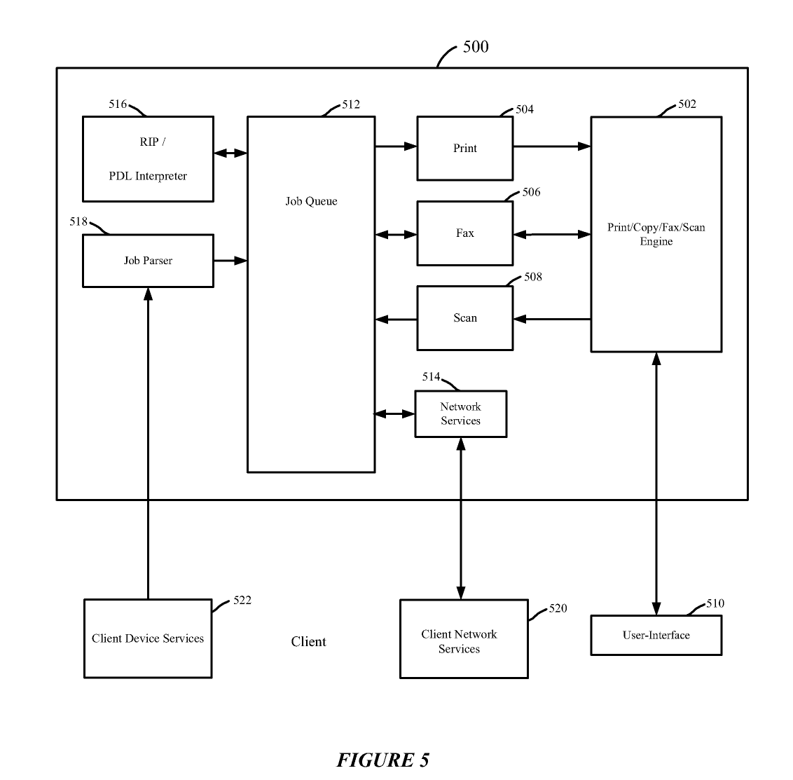

In accordance with one embodiment of the subject application, the document processing device 104 incorporates a backend component, designated as the controller 108, suitably adapted to facilitate the operations of the document processing device 104, as will be understood by those skilled in the art. Preferably, the controller 108 is embodied as hardware, software, or any suitable combination thereof, configured to control the operations of the associated document processing device 104, facilitate the display of images via the user interface 106, direct the manipulation of electronic image data, and the like. For purposes of explanation, the controller 108 is used to refer to any myriad of components associated with the document processing device 104, including hardware, software, or combinations thereof, functioning to perform, cause to be performed, control, or otherwise direct the methodologies described hereinafter. It will be understood by those skilled in the art that the methodologies described with respect to the controller 108 is capable of being performed by any general purpose computing system, known in the art, and thus the controller 108 is representative of such general computing devices and is intended as such when used hereinafter. Furthermore, the use of the controller 108 hereinafter is for the example embodiment only, and other embodiments, which will be apparent to one skilled in the art, are capable of employing the system and method for obtaining address data from a portable device to a document processing device. The functioning of the controller 108 will better be understood in conjunction with the block diagrams illustrated in FIGS. 4 and 5, explained in greater detail below.

Communicatively coupled to the document processing device 104 is a data storage device 110. In accordance with the one embodiment of the subject application, the data storage device 110 is any mass storage device known in the art including, for example and without limitation, magnetic storage drives, a hard disk drive, optical storage devices, flash memory devices, or any suitable combination thereof. In one embodiment, the data storage device 110 is suitably adapted to store scanned image data, modified image data, redacted data, user information, document data, image data, electronic database data, or the like. It will be appreciated by those skilled in the art that while illustrated in FIG. 1 as being a separate component of the system 100, the data storage device 110 is capable of being implemented as an internal storage component of the document processing device 104, a component of the controller 108, or the like, such as, for example and without limitation, an internal hard disk drive, or the like. In accordance with one embodiment of the subject application, the data storage device 110 is capable of storing document processing instructions, usage data, user interface data, job control data, controller status data, component execution data, images, advertisements, user information, location information, output templates, mapping data, multimedia data files, fonts, and the like. The document processing device of FIG. 1 also includes a portable storage device reader 114, which is suitably adapted to receive and access a myriad of different portable storage devices. Examples of such portable storage devices include, for example and without limitation, flash-based memory such as SD, xD, Memory Stick, compact flash, CD-ROM, DVD-ROM, USB flash drives, or other magnetic or optical storage devices, as will be known in the art.

Also depicted in FIG. 1 is a plurality of user devices, illustrated as portable telecommunications devices 116 and 122. Each portable telecommunications device 116 and 122 is preferably in data communication with the document processing device 104 via corresponding communications links 120 and 126. It will be appreciated by those skilled in the art that the portable telecommunication devices 116 and 122 are shown in FIG. 1 as a smart cellular telephone and a portable electronic book reading device for illustration purposes only. As will be understood by those skilled in the art, the portable telecommunication devices 116 and 122 are representative of any personal computing device known in the art including, for example and without limitation, a laptop computer, a personal computer, a personal data assistant, a web-enabled cellular telephone, a smart phone, a proprietary network device, a portable electronic book reading device, or other web-enabled electronic device. According to one embodiment of the subject application, the portable telecommunication devices 116 and 122 further include software, hardware, or a suitable combination thereof configured to interact with the document processing device 104 or the like. Preferably, each portable telecommunication device 116 and 122 includes a suitable personal area network interface, such as a BLUETOOTH transceiver, an RF transceiver, and the like.

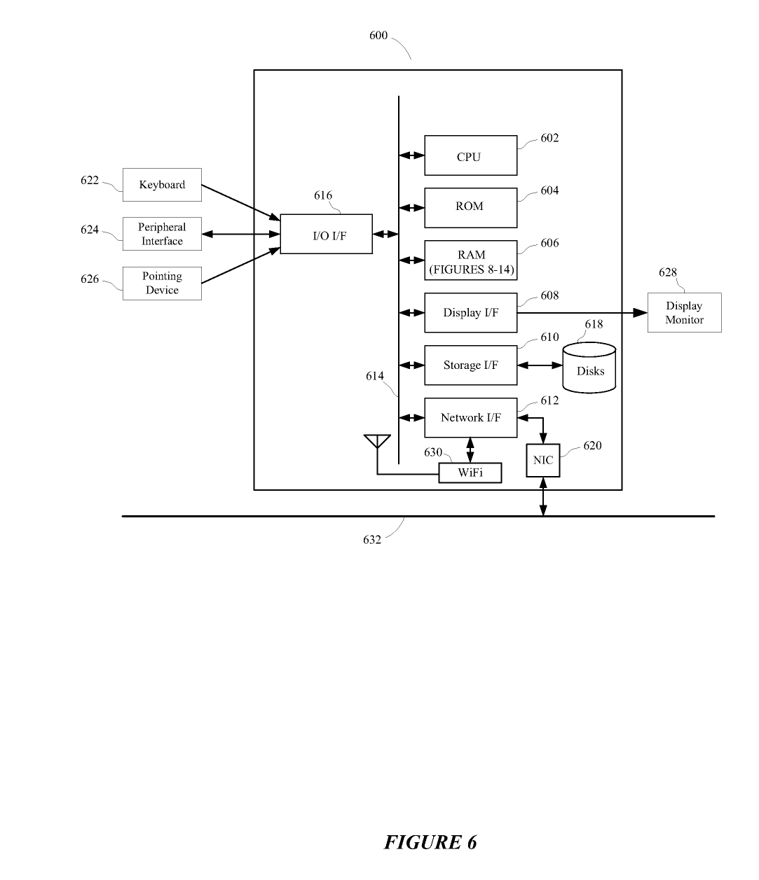

The communications links 120 and 126 are any suitable channel of data communications known in the art including, but not limited to wireless communications, for example and without limitation, BLUETOOTH, WiMax, 802.11a, 802.11b, 802.11g, 802.11(x), a proprietary communications channel, infrared, optical, the public switched telephone network, or any suitable wireless data transmission system, or wired communications known in the art. Preferably, the portable telecommunication devices 116 and 122 are suitably adapted to provide contact information, address book data, document data, job data, user interface data, image data, monitor document processing jobs, employ thin-client interfaces, generate display data, generate output data, or the like, with respect to the document processing device 104, or any other similar device with which the portable telecommunication devices 116 and 122 are capable of communicating. According to one embodiment of the subject application, the portable telecommunication devices 116 and 122 are capable of implementing various graphical user interface applications for interacting with a user, as will be appreciated by those skilled in the art to include a physical keyboard, a soft keyboard via an associated touch screen interface, or a suitable combination thereof. The functioning of the portable telecommunication devices 116 and 122 will better be understood in conjunction with the block diagram illustrated in FIG. 6, explained in greater detail below.

Communicatively coupled to the portable telecommunication devices 116 and 122 are data storage devices 118 and 124, respectively. According to the foregoing example embodiment, the data storage devices 118 and 124 are any mass storage device, or plurality of such devices, known in the art including, for example and without limitation, magnetic storage drives, a hard disk drive, optical storage devices, flash memory devices, or any suitable combination thereof. In such an embodiment, the data storage devices 118 and 124 are suitably adapted to store operating systems, address book data, personal information, account information, electronic book data, identification data, regional data, thin client interface data, keyboard layout data, keyboard property data, HTML keyboard data, JavaScript keyboard data, update software, policy information, and the like.

It will be appreciated by those skilled in the art that while illustrated in FIG. 1 as being a separate component of the system 100, the data storage devices 118 and 124 are capable of being implemented as an internal storage component of the portable telecommunication devices 116 and 122.

The system 100 illustrated in FIG. 1 further depicts a backend component, shown as the server 128, in data communication with the computer network 102 via a communications link 132. It will be appreciated by those skilled in the art that the server 128 is shown in FIG. 1 as a component of the system 100 for example purposes only, and the subject application is capable of implementation without the use of a separate backend server component, e.g. the server 128 is capable of implementation via the document processing device 104, or via one of a plurality of portable devices 116 and 122. The skilled artisan will appreciate that the server 128 comprises hardware, software, and combinations thereof suitably adapted to provide one or more services, web-based applications, communication with thin client interfaces, storage options, and the like, to networked devices. In accordance with one example embodiment of the subject application, the server 128 includes various components, implemented as hardware, software, or a combination thereof, for managing retention of secured documents, text data, performing searches, comparisons, maintaining database entries, account information, receiving payment data, retrieval of documents, and the like, which are accessed via the computer network 102.

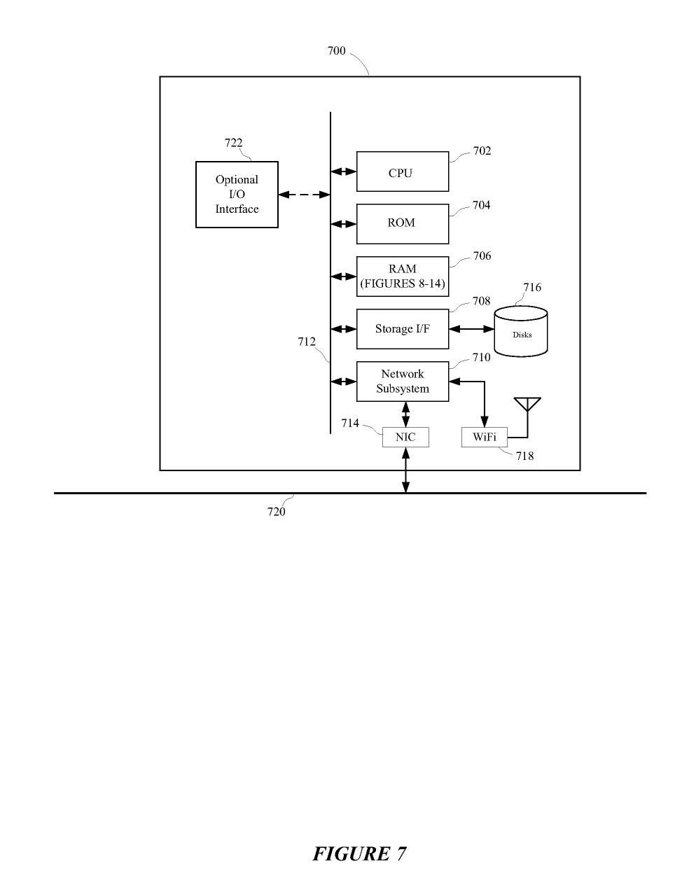

The communications link 132 is any suitable data communications means known in the art including, but not limited to wireless communications comprising, for example and without limitation Bluetooth, WiMax, 802.11a, 802.11b, 802.11g, 802.11(x), a proprietary communications network, infrared, the public switched telephone network, optical, or any suitable wireless data transmission system, or wired communications known in the art. It will further be appreciated by those skilled in the art that the components described with respect to the server 128 are capable of implementation on any suitable computing device coupled to the computer network 102, e.g. the controller 108, or the like. The functioning of the server 128 will better be understood in conjunction with the block diagram illustrated in FIG. 7, explained in greater detail below.

Communicatively coupled to the server 128 is the data storage device 130. According to the foregoing example embodiment, the data storage device 130 is any mass storage device, or plurality of such devices, known in the art including, for example and without limitation, magnetic storage drives, a hard disk drive, optical storage devices, flash memory devices, or any suitable combination thereof. In such an embodiment, the data storage device 130 is suitably adapted to store account information, document processing device identification data, client device identification data, regional data, thin client interface data, keyboard layout data, keyboard property data, HTML keyboard data, JavaScript keyboard data, update software, policy information, and the like. It will be appreciated by those skilled in the art that while illustrated in FIG. 1 as being a separate component of the system 100, the data storage device 130 is capable of being implemented as an internal storage component of the server 130, or the like, such as, for example and without limitation, an internal hard disk drive, or the like.

Turning now to FIG. 2, illustrated is a representative architecture of a suitable device 200, shown in FIG. 1 as the document processing device 104, on which operations of the subject system are completed. Included is a processor 202, suitably comprised of a central processor unit. However, it will be appreciated that the processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration data, and other routines or data used for operation of the device 200.

Also included in the device 200 is random access memory 206, suitably formed of dynamic random access memory, static random access memory, or any other suitable, addressable memory system. Random access memory provides a storage area for data instructions associated with applications and data handling accomplished by the processor 202.

A storage interface 208 suitably provides a mechanism for volatile, bulk or long term storage of data associated with the device 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the device 200 to communicate to other devices. The network interface subsystem 210 suitably interfaces with one or more connections with external devices to the device 200. By way of example, illustrated is at least one network interface card 214 for data communication with fixed or wired networks, such as Ethernet, token ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface card 214 is interconnected for data interchange via a physical network 220, suitably comprised of a local area network, wide area network, or a combination thereof.

Data communication between the processor 202, read only memory 204, random access memory 206, storage interface 208 and the network subsystem 210 is suitably accomplished via a bus data transfer mechanism, such as illustrated by the bus 212.

Suitable executable instructions on the device 200 facilitate communication with a plurality of external devices, such as workstations, document rendering devices, other servers, or the like. While, in operation, a typical device operates autonomously, it is to be appreciated that direct control by a local user is sometimes desirable, and is suitably accomplished via an optional input/output interface 222 to a user input/output panel 224 as will be appreciated by one of ordinary skill in the art.

Also in data communication with the bus 212 are interfaces to one or more document processing engines. In the illustrated embodiment, printer interface 226, copier interface 228, scanner interface 230, and facsimile interface 232 facilitate communication with printer engine 234, copier engine 236, scanner engine 238, and facsimile engine 240, respectively. It is to be appreciated that the device 200 suitably accomplishes one or more document processing functions. Systems accomplishing more than one document processing operation are commonly referred to as multifunction peripherals or multifunction devices.

Turning now to FIG. 3, illustrated is a suitable document processing device, depicted in FIG. 1 as the document processing device 104, for use in connection with the disclosed system. FIG. 3 illustrates suitable functionality of the hardware of FIG. 2 in connection with software and operating system functionality as will be appreciated by one of ordinary skill in the art. The document rendering device 300 suitably includes an engine 302 which facilitates one or more document processing operations.

The document processing engine 302 suitably includes a print engine 304, facsimile engine 306, scanner engine 308 and console panel 310. The print engine 304 allows for output of physical documents representative of an electronic document communicated to the processing device 300. The facsimile engine 306 suitably communicates to or from external facsimile devices via a device, such as a fax modem.

The scanner engine 308 suitably functions to receive hard copy documents and in turn image data corresponding thereto. A suitable user interface, such as the console panel 310, suitably allows for input of instructions and display of information to an associated user. It will be appreciated that the scanner engine 308 is suitably used in connection with input of tangible documents into electronic form in bitmapped, vector, or page description language format, and is also suitably configured for optical character recognition. Tangible document scanning also suitably functions to facilitate facsimile output thereof.

In the illustration of FIG. 3, the document processing engine also comprises an interface 316 with a network via driver 326, suitably comprised of a network interface card. It will be appreciated that a network thoroughly accomplishes that interchange via any suitable physical and non-physical layer, such as wired, wireless, or optical data communication.

The document processing engine 302 is suitably in data communication with one or more device drivers 314, which device drivers allow for data interchange from the document processing engine 302 to one or more physical devices to accomplish the actual document processing operations. Such document processing operations include one or more of printing via driver 318, facsimile communication via driver 320, scanning via driver 322 and a user interface functions via driver 324. It will be appreciated that these various devices are integrated with one or more corresponding engines associated with the document processing engine 302. It is to be appreciated that any set or subset of document processing operations are contemplated herein. Document processors which include a plurality of available document processing options are referred to as multi-function peripherals.

Turning now to FIG. 4, illustrated is a representative architecture of a suitable backend component, i.e., the controller 400, shown in FIG. 1 as the controller 108, on which operations of the subject system 100 are completed. The skilled artisan will understand that the controller 400 is representative of any general computing device, known in the art, capable of facilitating the methodologies described herein. Included is a processor 402, suitably comprised of a central processor unit. However, it will be appreciated that processor 402 may advantageously be composed of multiple processors working in concert with one another as will be appreciated by one of ordinary skill in the art. Also included is a non-volatile or read only memory 404 which is advantageously used for static or fixed data or instructions, such as BIOS functions, system functions, system configuration data, and other routines or data used for operation of the controller 400.

Also included in the controller 400 is random access memory 406, suitably formed of dynamic random access memory, static random access memory, or any other suitable, addressable and writable memory system. Random access memory provides a storage area for data instructions associated with applications and data handling accomplished by processor 402.

A storage interface 408 suitably provides a mechanism for non-volatile, bulk or long term storage of data associated with the controller 400. The storage interface 408 suitably uses bulk storage, such as any suitable addressable or serial storage, such as a disk, optical, tape drive and the like as shown as 416, as well as any suitable storage medium as will be appreciated by one of ordinary skill in the art.

A network interface subsystem 410 suitably routes input and output from an associated network allowing the controller 400 to communicate to other devices. The network interface subsystem 410 suitably interfaces with one or more connections with external devices to the device 400. By way of example, illustrated is at least one network interface card 414 for data communication with fixed or wired networks, such as Ethernet, token ring, and the like, and a wireless interface 418, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 414 is interconnected for data interchange via a physical network 420, suitably comprised of a local area network, wide area network, or a combination thereof.

Data communication between the processor 402, read only memory 404, random access memory 406, storage interface 408 and the network interface subsystem 410 is suitably accomplished via a bus data transfer mechanism, such as illustrated by bus 412.

Also in data communication with the bus 412 is a document processor interface 422. The document processor interface 422 suitably provides connection with hardware 432 to perform one or more document processing operations. Such operations include copying accomplished via copy hardware 424, scanning accomplished via scan hardware 426, printing accomplished via print hardware 428, and facsimile communication accomplished via facsimile hardware 430. It is to be appreciated that the controller 400 suitably operates any or all of the aforementioned document processing operations. Systems accomplishing more than one document processing operation are commonly referred to as multifunction peripherals or multifunction devices.

Functionality of the subject system 100 is accomplished on a suitable document rendering device, such as the document processing device 104, which includes the controller 400 of FIG. 4, (shown in FIG. 1 as the controller 108) as an intelligent subsystem associated with a document rendering device. In the illustration of FIG. 5, controller function 500 in the preferred embodiment includes a document processing engine 502. A suitable controller functionality is that incorporated into the Toshiba e-Studio system in the preferred embodiment. FIG. 5 illustrates suitable functionality of the hardware of FIG. 4 in connection with software and operating system functionality as will be appreciated by one of ordinary skill in the art.

In the preferred embodiment, the engine 502 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document rendering devices that perform one or more of the document processing operations listed above.

The engine 502 is suitably interfaced to a user interface panel 510, which panel allows for a user or administrator to access functionality controlled by the engine 502. Access is suitably enabled via an interface local to the controller, or remotely via a remote thin or thick client.

The engine 502 is in data communication with the print function 504, facsimile function 506, and scan function 508. These functions facilitate the actual operation of printing, facsimile transmission and reception, and document scanning for use in securing document images for copying or generating electronic versions.

A job queue 512 is suitably in data communication with the print function 504, facsimile function 506, and scan function 508. It will be appreciated that various image forms, such as bit map, page description language or vector format, and the like, are suitably relayed from the scan function 308 for subsequent handling via the job queue 512.

The job queue 512 is also in data communication with network services 514. In a preferred embodiment, job control, status data, or electronic document data is exchanged between the job queue 512 and the network services 514. Thus, suitable interface is provided for network based access to the controller function 500 via client side network services 520, which is any suitable thin or thick client. In the preferred embodiment, the web services access is suitably accomplished via a hypertext transfer protocol, file transfer protocol, uniform data diagram protocol, or any other suitable exchange mechanism. The network services 514 also advantageously supplies data interchange with client side services 520 for communication via FTP, electronic mail, TELNET, or the like. Thus, the controller function 500 facilitates output or receipt of electronic document and user information via various network access mechanisms.

The job queue 512 is also advantageously placed in data communication with an image processor 516. The image processor 516 is suitably a raster image process, page description language interpreter or any suitable mechanism for interchange of an electronic document to a format better suited for interchange with device functions such as print 504, facsimile 506 or scan 508.

Finally, the job queue 512 is in data communication with a parser 518, which parser suitably functions to receive print job language files from an external device, such as client device services 522. The client device services 522 suitably include printing, facsimile transmission, or other suitable input of an electronic document for which handling by the controller function 500 is advantageous. The parser 518 functions to interpret a received electronic document file and relay it to the job queue 512 for handling in connection with the afore-described functionality and components.

Turning now to FIG. 6, illustrated is a hardware diagram of a suitable workstation 600, shown in FIG. 1 as the portable telecommunication devices 116 and 122 or the workstation 128, for use in connection with the subject system. A suitable workstation includes a processor unit 602 which is advantageously placed in data communication with read only memory 604, suitably non-volatile read only memory, volatile read only memory or a combination thereof, random access memory 606, display interface 608, storage interface 610, and network interface 612. In a preferred embodiment, interface to the foregoing modules is suitably accomplished via a bus 614.

The read only memory 604 suitably includes firmware, such as static data or fixed instructions, such as BIOS, system functions, configuration data, and other routines used for operation of the workstation 600 via CPU 602.

The random access memory 606 provides a storage area for data and instructions associated with applications and data handling accomplished by the processor 602.

The display interface 608 receives data or instructions from other components on the bus 614, which data is specific to generating a display to facilitate a user interface. The display interface 608 suitably provides output to a display terminal 628, suitably a video display device such as a monitor, LCD, plasma, or any other suitable visual output device as will be appreciated by one of ordinary skill in the art.

The storage interface 610 suitably provides a mechanism for non-volatile, bulk or long term storage of data or instructions in the workstation 600. The storage interface 610 suitably uses a storage mechanism, such as storage 618, suitably comprised of a disk, tape, CD, DVD, or other relatively higher capacity addressable or serial storage medium.

The network interface 612 suitably communicates to at least one other network interface, shown as network interface 620, such as a network interface card, and wireless network interface 630, such as a WiFi wireless network card. It will be appreciated that by one of ordinary skill in the art that a suitable network interface is comprised of both physical and protocol layers and is suitably any wired system, such as Ethernet, token ring, or any other wide area or local area network communication system, or wireless system, such as WiFi, WiMax, or any other suitable wireless network system, as will be appreciated by one of ordinary skill in the art. In the illustration, the network interface 620 is interconnected for data interchange via a physical network 632, suitably comprised of a local area network, wide area network, or a combination thereof.

An input/output interface 616 in data communication with the bus 614 is suitably connected with an input device 622, such as a keyboard or the like. The input/output interface 616 also suitably provides data output to a peripheral interface 624, such as a USB, universal serial bus output, SCSI, Firewire (IEEE 1394) output, or any other interface as may be appropriate for a selected application. Finally, the input/output interface 616 is suitably in data communication with a pointing device interface 626 for connection with devices, such as a mouse, light pen, touch screen, or the like.

Turning now to FIG. 7, illustrated is a representative architecture of a suitable server 700 (depicted in FIG. 1 as the server 128), on which operations of the subject system are completed. Included is a processor 702, suitably comprised of a central processor unit. However, it will be appreciated that processor 702 may advantageously be composed of multiple processors working in concert with one another as will be appreciated by one of ordinary skill in the art. Also included is a non-volatile or read only memory 704 which is advantageously used for static or fixed data or instructions, such as BIOS functions, system functions, system configuration, and other routines or data used for operation of the server 700.

Also included in the server 700 is random access memory 706, suitably formed of dynamic random access memory, static random access memory, or any other suitable, addressable memory system. Random access memory provides a storage area for data instructions associated with applications and data handling accomplished by the processor 702.

A storage interface 708 suitably provides a mechanism for volatile, bulk or long term storage of data associated with the server 700. The storage interface 708 suitably uses bulk storage, such as any suitable addressable or serial storage, such as a disk, optical, tape drive and the like as shown as 716, as well as any suitable storage medium as will be appreciated by one of ordinary skill in the art.

A network interface subsystem 710 suitably routes input and output from an associated network allowing the server 700 to communicate to other devices. The network interface subsystem 710 suitably interfaces with one or more connections with external devices to the server 700. By way of example, illustrated is at least one network interface card 714 for data communication with fixed or wired networks, such as Ethernet, token ring, and the like, and a wireless interface 718, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 714 is interconnected for data interchange via a physical network 720, suitably comprised of a local area network, wide area network, or a combination thereof.

Data communication between the processor 702, read only memory 704, random access memory 706, storage interface 708 and the network subsystem 710 is suitably accomplished via a bus data transfer mechanism, such as illustrated by bus 712.

Suitable executable instructions on the server 700 facilitate communication with a plurality of external devices, such as workstations, document processing devices, other servers, or the like. While, in operation, a typical server operates autonomously, it is to be appreciated that direct control by a local user is sometimes desirable, and is suitably accomplished via an optional input/output interface 722 as will be appreciated by one of ordinary skill in the art.

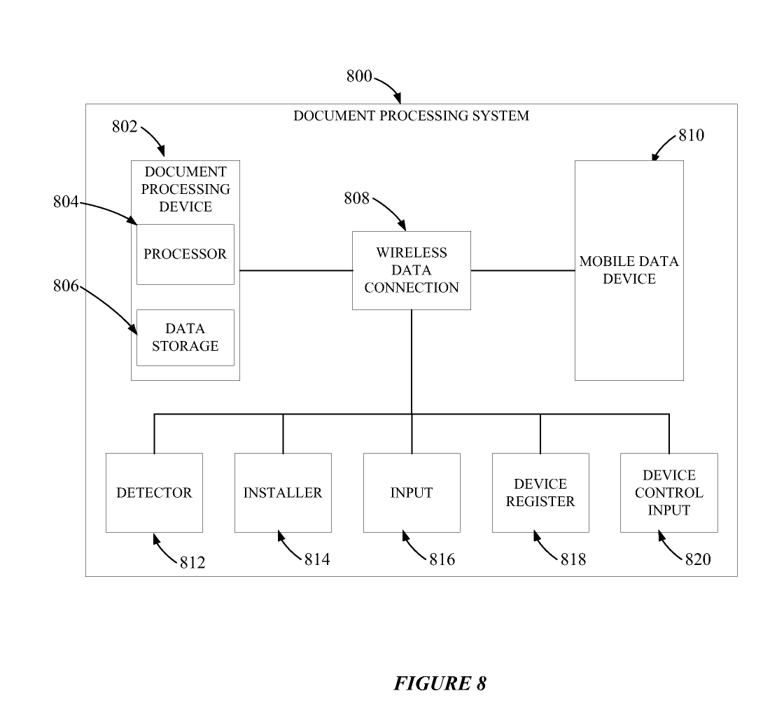

Referring now to FIG. 8, illustrated is a block diagram of a document processing system 800 in accordance with one embodiment of the subject application. The document processing system 800 of FIG. 8 includes a document processing device 802 equipped with a processor 804 and an associated data storage 806. The system 800 further includes a wireless data connector 808 that is configured for establishment of a wireless data connection between the document processing device 802 and an associated mobile data device 810. A detector 812 is also incorporated in the system 800 that is operable to a data connection with the associated mobile data device 810 via the wireless data connector 808. The system 800 further incorporates an installer 814 that is configured to initiate a remote installation of a software interface for the document processing device 802 on the mobile data device 810 via the wireless data connection based upon the output from the detector 812.

The document processing system 800, as illustrated in FIG. 8, further includes an input 816 that is operable to receive a multicast probe via the wireless data connection from the mobile data device 810 that is initiated based upon operation of the software interface after installation thereon. The system 800 also incorporates a device register 818 that is configured to register the mobile data device 810 with the document processing device 802 in accordance with a response to the multicast probe. The document processing system 800 includes a device control input 820 that is operable to receive control data from the mobile data device 810. Preferably, this control data is received via the wireless data connection. According to one embodiment of the subject application, the control data is generated by the software interface configured to commence one or more document processing operations on the document processing device 802.

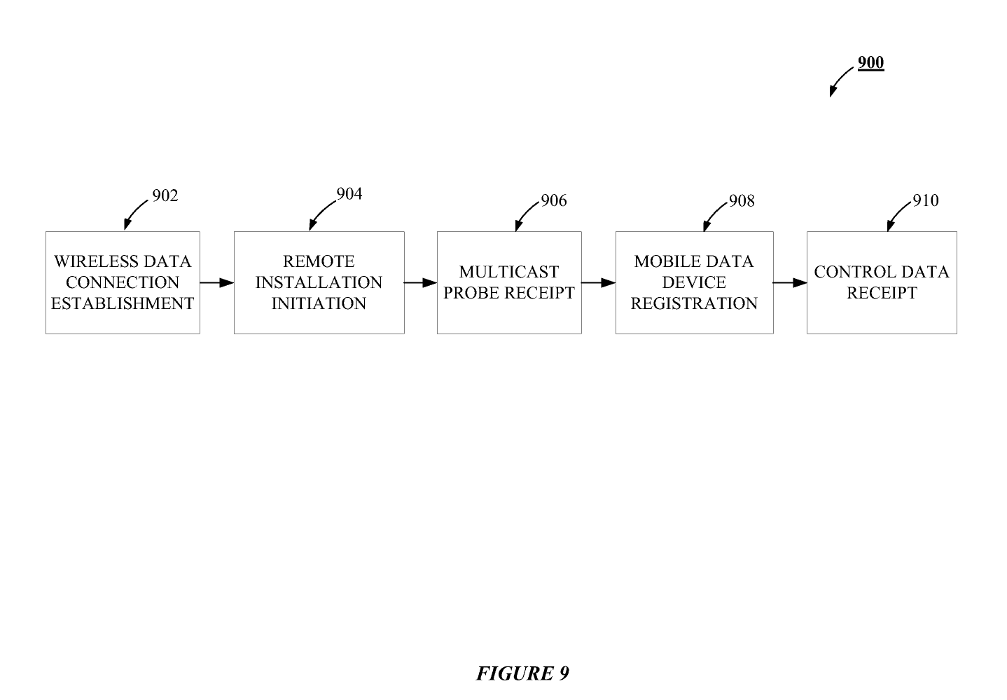

Turning now to FIG. 9, illustrated is a functional diagram of a system 900 for document processing in accordance with one embodiment of the subject application. As shown in FIG. 9, wireless data connection establishment 902 first occurs of a connection between a mobile data device and a document processing device equipped with a processor and a data storage. Remote installation initiation 904 is then performed of the remote installation of a software interface for the document processing device on the mobile data device via the wireless data connection.

Multicast probe receipt 906 then occurs via the wireless data connection from the mobile data device initiated in accordance with operation of the software interface after its installation. Mobile data device registration 908 is then performed with the document processing device based upon a response to the multicast probe. Control data receipt 910 then occurs of control data from the mobile data device via the wireless data connection. Preferably, this control data is generated by the software interface for commencement of at least one document processing operation on the document processing device.

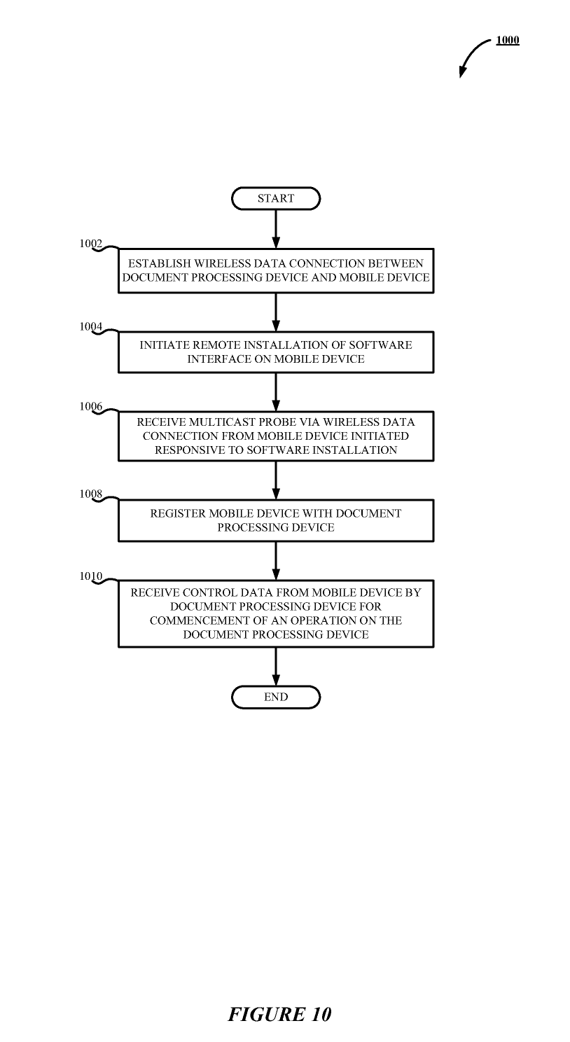

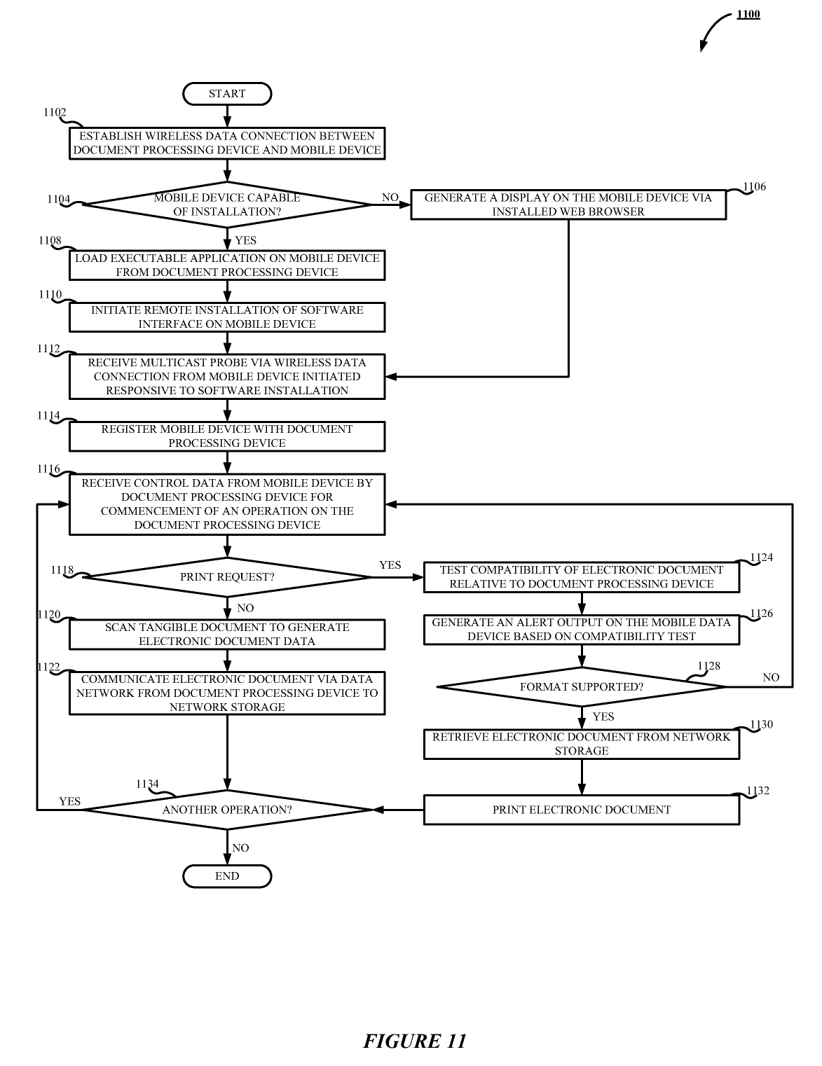

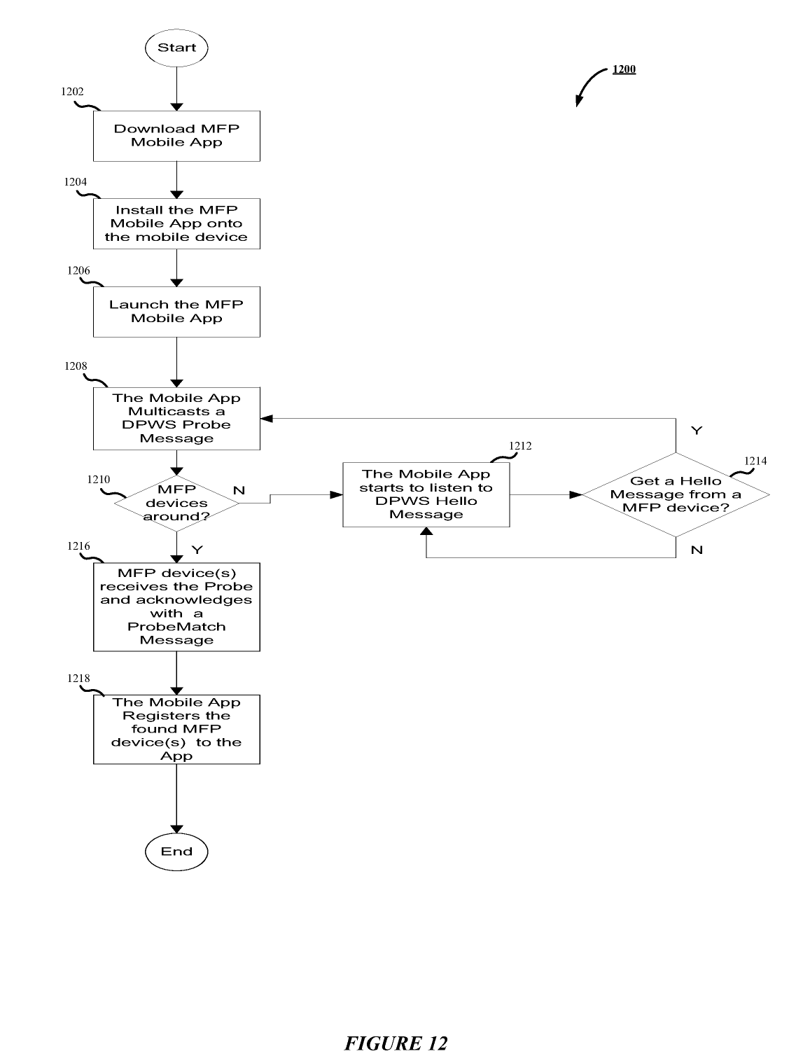

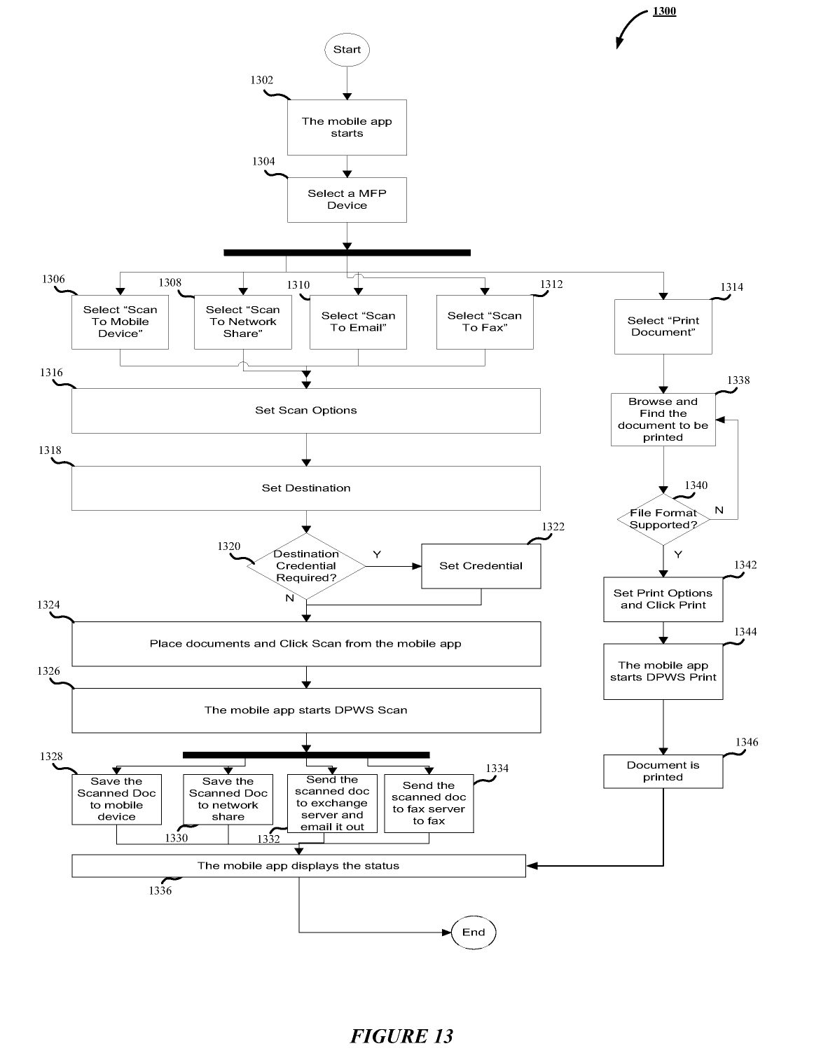

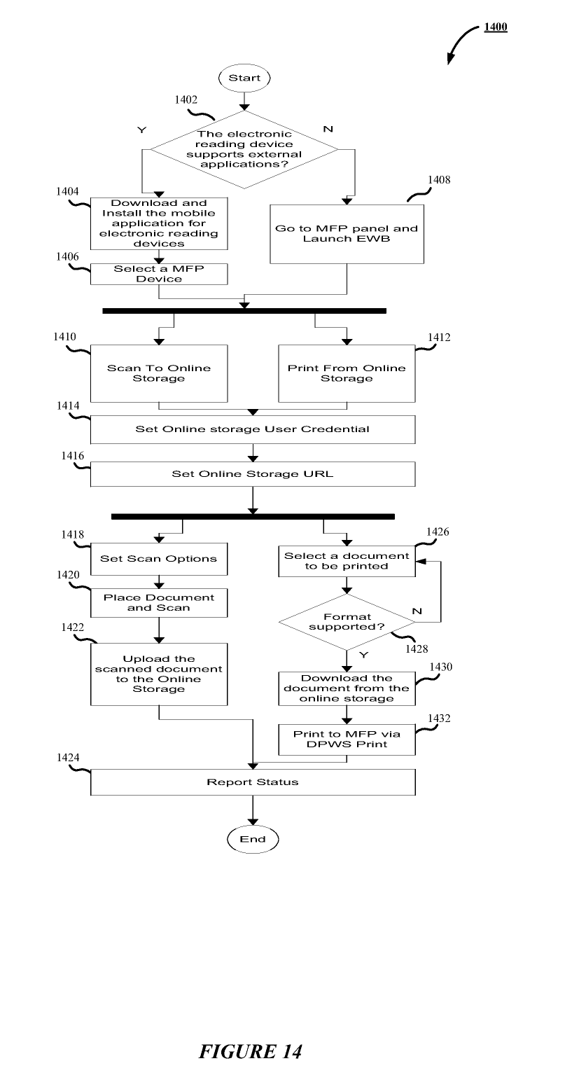

The skilled artisan will appreciate that the subject system 100 and components described above with respect to FIG. 1, FIG. 2, FIG. 3, FIG. 4, FIG. 5, FIG. 6, FIG. 7, FIG. 8, and FIG. 9 will be better understood in conjunction with the methodologies described hereinafter with respect to FIG. 10 and FIG. 11, as well as the example illustrations of the embodiments depicted in FIG. 12, FIG. 13, and FIG. 14. Turning now to FIG. 10, there is shown a flowchart 1000 illustrating a document processing method in accordance with one embodiment of the subject application. Beginning at step 1002, a wireless data connection is established between an associated mobile data device and a document processing device, which includes a processor and associated data storage.

At step 1004, a remote installation of a software interface for the document processing device is initiated on the mobile data device via the wireless data connection. A multicast probe is then received at step 1006 via the wireless data connection from the mobile data device initiated in accordance with operation of the software interface after installation thereon. The mobile data device is then registered, at step 1008, with the document processing device in accordance with a response to the multicast probe. Thereafter, at step 1010, control data is received from the mobile data device via the wireless data connection. Preferably, the control data is generated by the software interface operable to commence at least one document processing operation on the document processing device.

Referring now to FIG. 11, there is depicted a flowchart 11 illustrating a document processing method. Reference is made hereinafter to the mobile data device being a wireless portable data processing device, e.g. a smart phone, electronic reading device, web-enabled cellular telephone, proprietary communications device, or the like, including the portable devices 116 and 122 depicted in FIG. 1. It will be understood by those skilled in the art that such usage is for example purposes only, and the subject methodology is not limited to such devices. The methodology set forth in the example embodiment of FIG. 11 begins at step 1102, whereupon a wireless connection is established between the document processing device 104 and the mobile data device 116 or 122. Preferably, the document processing device 104 includes a processor and associated data storage 110, as further detailed in FIGS. 1-5 above.

A determination is then made at step 1104 whether the mobile data device 116 or 122 is capable of installation of a dedicated application for interacting with the document processing device 104. In accordance with one embodiment of the subject application, the application is capable of being communicated from the document processing device 104, from the server 128 via the network 102, or the like. The distinction between a mobile device capable of installation of a third party application (smart phone, personal data assistant, etc.) and non-capable (web-enabled cell-phone, electronic reading device, etc.) will be apparent to those skilled in the art. For purposes of FIG. 11, the mobile device 116 corresponds to a mobile device capable of accepting external applications, whereas the mobile device 122 corresponds to a mobile device that is not capable of installing an application. Thus, upon a determination at step 1104 that the mobile device 122 is not capable of installation of an application, flow proceeds to step 1106. At step 1106, a display is generated on the mobile device 122 via the embedded web browser, as will be appreciated by those skilled in the art. Operations then proceed to step 1112, discussed in greater detail below.

Upon a determination at step 1104 that the mobile device 116 is capable of installation of an application, flow progresses to step 1108. At step 1108, an executable application is loaded onto the mobile device 116 from the document processing device 104. The remote installation of the software interface associated with the application is then initiated at step 1110 on the mobile device 116. A multicast probe is then received via the wireless data connection by the controller 108 or other suitable component associated with the document processing device 104 at step 1112. Preferably, the multicast probe, e.g. a Devices Profile for Web Services (DPWS) probe, is received from the mobile data device 116 in response to the installation of the software application, or after display of the webpage loaded via the installed web browser of the mobile device 122. Further discussions of the multicast probe are set forth below with respect to FIGS. 12-14.

The mobile device 116 or 122 is then registered with the document processing device 104 at step 1114. At step 1116, control data is received from the mobile data device 116 or 122 for control of the document processing device 104 for commencement of a document processing operation. A determination is then made at step 1118 whether the control data includes a print request, i.e. a request to print a document stored locally (storage 118 or 124) or via the network storage 130. Upon a negative determination, i.e. a scan operation is selected, a tangible document is scanned at step 1120 via interactions of the document processing device 104, the associated user, and the mobile device 116 or 122 resulting in the generation of electronic document data. In accordance with one embodiment of the subject application, a graphical user interface is generated on the mobile devices 116 or 122 to facilitate remote user selection and control of the document processing device 104.

At step 1122, the electronic document is communicated via the computer network 102 to network storage 130 (i.e. for later access by the mobile device 116 or 122). A determination is then made at step 1134 whether another document processing operation is requested. When no further operations are required, operations with respect to FIG. 11 terminate. Upon a determination that additional operations remain, flow returns to step 1116 with the receipt of control data indicative of the additional operations.

Returning to step 1118, upon a determination that a print request has been received in the control data of step 1116, flow proceeds to step 1124. At step 1124, the compatibility of the document indicated by the control data is tested relative to the document processing device 104, e.g. supported format. An alert output is then generated at step 1126 on the mobile device 116 or 122 based upon the compatibility test performed at step 1124. It will be appreciated by those skilled in the art that such an alert output is capable of indicating a supported format or an unsupported format. In the event, as determined at step 1128, the format is not supported, the alert so indicates and flow returns to step 1116 for receipt of control data inclusive of a new electronic document for printing. When the format of the selected electronic document is supported, operations progress to step 1130.

At step 1130, an electronic document is retrieved by the document processing device 104 from network storage 130. It will be appreciated by those skilled in the art that the document is also capable of being retrieved directly from the mobile device 116 or 122 instigating the operation. The electronic document is then printed by the appropriate component of the document processing device 104 at step 1132, following which a determination is made at step 1134 whether another operation of the document processing device 104 has been received. A positive determination returns flow of FIG. 11 to step 1116, while a negative determination terminates operations.

Referring now to FIG. 12, there is shown a discovery example of a portable device using the systems and methods of the subject application. The example implementation of FIG. 12 begins at step 1202, whereupon a mobile user associated with a mobile data device, i.e. the portable telecommunications device 116 or 122, downloads a document processing device mobile application via a manufacturer's website, via the mobile carrier's store, via a dedicated server 128, or the like. According to this example embodiment, the mobile application is a software module operable on the portable telecommunication device 116 or 122 that facilitates the remote control of operations of the document processing device 104 in accordance with the subject application. The skilled artisan will appreciate that, for the purpose of illustrating the example embodiment of FIG. 12, “mobile device” is used interchangeably with “portable telecommunication device”. In addition, “multifunction peripheral device” or “MFP” as used in FIGS. 12-14 is indicative of a document processing device, such as the document processing device 104 depicted in FIG. 1, thus the terms “multifunction peripheral device”, “MFP”, and “document processing device” are used interchangeably in FIGS. 12-14 in reference to the document processing device 104 of FIG. 1.

After downloading the mobile application, flow proceeds to step 1204, whereupon the associated user directs the installation of the mobile application on the mobile device (portable telecommunication device 116 or 122). The mobile application is then launched via the operating system of the mobile device at step 1206. Preferably, the user selects an icon displayed on the mobile device 116 or 122 associated with the installed mobile application. At step 1208, the mobile application multicasts a Devices Profile for Web Services (DPWS) probe message.

A determination is then made at step 1210 whether any document processing devices are in range of the mobile device 116 or 122 that support DPWS protocol. When it is determined at step 1210 that no document processing devices are available that support DPWS protocol, flow proceeds to step 1212, whereupon the mobile application begins to listen for DPWS Hello Messages that will be sent out when a suitable document processing device starts up. In the event that a Hello Message is received at step 1214, flow returns to step 1208, whereupon the mobile application on the mobile device 116 or 122 sends the DPWS Probe Message. Upon a positive determination at step 1210, the document processing device 104 (i.e. MFP) receives the probe message and acknowledges receipt via a ProbeMatch message that is sent to the mobile device 116 or 122 at step 1216.

At step 1218, the mobile application receives the ProbeMatch message and registers the MFP to the device pool for the mobile user to use later. Preferably, the mobile application operating on the mobile device 116 or 122 continues sending probe messages until all the document processing devices around the mobile device 116 or 122 are registered.

The preceding methodology 1200 of FIG. 12 will be better understood in conjunction with the flowchart 1300 of FIG. 13, which illustrates operational control by the mobile device 116 or 122 of the document processing device 104. Thus, at step 1302, a mobile MFP application user starts the application on the mobile device, e.g. the portable telecommunication device 122. The skilled artisan will appreciate that, for the purpose of illustrating the example embodiment of FIG. 13, “mobile device” is used interchangeably with “portable telecommunication device”. In addition, while reference is made in FIGS. 12 and 13 to the downloading and installation of a dedicated software application, the subject application is equally capable of facilitating operations using a web browser on the mobile device 122, i.e. a web application, such as OpenPlatform, designed for mobile devices via their native browsers.

At step 1304, the mobile use selects a desired document processing device 104. The user is then prompted to select a feature, e.g. Scan to the device 1306, Scan to Network Share 1308, Scan to Email 1310, Scan to Fax 1312, or Print Document from the device 1314, and the like. In the event that the user selects one of the scan operations 1306-1312, flow proceeds to step 1316, whereupon the scan options for the document processing device 104 are set via the mobile device 122. Suitable options include, for example and without limitation, file output format, resolution, color, and the like. The destination is then set for the output of the scan operation at step 1318.

A determination is then made at step 1320 whether destination credentials are required. Upon a positive determination at step 1320, flow proceeds to step 1322, whereupon the user enters his/her credential for the scan destination when such authentication is needed. After inputting the necessary credentials, or when no such credentials are required, operations progress to step 1324. At step 1324, the documents are placed on the feeder for the MFP scanner, and the user clicks the scan button from the mobile application operating on the mobile device 122.

At step 1326, the mobile application initiates the DPWS Scan and the document processing device 104 begins the document scanning operation. Thereafter, at steps 1328, 1330, 1332, or 1334, the document is sent to the destination selected above respectively at steps 1306, 1308, 1310, and 1312. The status of the document processing operation is then displayed on the mobile device 122 via the mobile application at step 1336.

In the event that the user has selected Print Document 1314, operations proceed to step 1338, whereupon the user is prompted to locate, via browsing on the mobile device 122, the document to be printed. At step 1340 a determination is made whether the format of the selected document is supported for printing by the document processing device 104. Upon a negative determination at step 1340, flow returns to step 1338, wherein the user is notified and asked to select a document in a format that is supported.

After confirming that the format of the selected document is supported by the selected document processing device 104, flow progresses to step 1342. At step 1342, the user sets the print options, e.g. duplex, number of copies, finishing options, print quality, and the like. The mobile application operating on the mobile device 122 then initiates DPWS Print at step 1344. At step 1346, the document is printed at the selected MFP 104. Flow then proceeds to step 1336, whereupon job status is reported back to the user via the mobile application.

Referring now to FIG. 14, there is shown a flowchart 1400 illustrating an example implementation of the subject application wherein the mobile device is a portable electronic reading device, such as the portable telecommunication device 116 of FIG. 1. Thus, for example purposes only, the terms “electronic reading device” and “portable telecommunication device” are used interchangeably with respect to the device 116 of FIG. 1. The methodology of FIG. 14 begins at step 1402, whereupon a determination is made whether the electronic reading device 116 supports external applications. In the event that external applications are supported, flow proceeds to step 1404, wherein a mobile application specified for the electronic reading device 116 is downloaded from the server 128 or other suitable source, as will be appreciated by those skilled in the art. The user is then prompted at step 1406 to select a suitable document processing device (MFP) 104. Operations then proceed to step 1410 or 1412, as discussed below. Upon a determination at step 1402 that the electronic reading device 116 does not support external applications, flow proceeds to step 1408. At step 1408, an embedded web browser is accessed via the user interface 106 of the document processing device 104 so as to access a suitable web application, e.g. OpenPlatform.

The methodology 1400 of FIG. 14 then provides two options to the user, a scan to online storage option 1410 (for reading via the electronic reading device 116) and a print from online storage 1412 (hardcopy from document readable electronic reading device 116). Regardless of selection made, flow proceeds to step 1414, whereupon the online storage user credentials are set for the operation, e.g. username/password, certificate, account number, or the like. At step 1416, the online storage URL is designated for the scan to or print from operation selected at 1410 or 1412.

When the user has selected the scan to storage operation 1410, flow proceeds from step 1418 through step 1422. When the user has selected the print from storage operation 1412, flow progresses from step 1426 through step 1432. Thus, at step 1418, the user sets the scanning options, places the document on the feeder and initiates the scan via the device 116 or user interface 106 at step 1420. Thereafter, at step 1422, the mobile application or OpenPlatform starts DPWS Scan and uploads the scanned document to the online storage via web service, i.e. now readable via the electronic reading device 1422. Flow then proceeds to step 1424, whereupon the job status is reported through either the mobile application on the electronic reading device 116 or the web application via the user interface 106 of the document processing device 104.

When the user has selected to print from online storage 1412, the mobile application or the web application, e.g. OpenPlatform, retrieves the selected documents from online storage associated with the electronic reading device 116 from which the user selects a desired to select which document to print at step 1426. In accordance with one embodiment of the subject application, the online storage is maintained via the server 128 in association with the electronic reading device 116. In another embodiment, the data storage 118 facilitate storage of documents local to the electronic reading device 116, as will be appreciated by those skilled in the art. A determination is then made at step 1428 whether the format of the selected document is supported by the mobile application or the web application. If the document is not supported, flow returns to step 1426 for another selection. If the document is supported, flow proces to step 1430, whereupon the document is downloaded by the application. At step 1432, the document is printed to the document processing device 104 via DPWS Print. Flow then proceeds to step 1424, whereupon the job status is reported through either the mobile application or the web application.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. A document processing system comprising:
a document processing device including a processor and associated data storage;
a wireless data connector operable to establish a wireless data connection between a document processing device and an associated mobile data device;
a detector operable to detect a data connection with the associated mobile data device via the wireless data connector;
an installer operable to initiate a remote installation of a software interface for the document processing device on the mobile data device via the wireless data connection in accordance with an output of the detector;
an input operable to receive a multicast probe via the wireless data connection from the mobile data device initiated in accordance with operation of the software interface after installation thereon;
a device register operable to register the mobile data device with the document processing device in accordance with a response to the multicast probe; and
a device control input operable to receive from the mobile data device, via the wireless data connection, control data generated by the software interface operable to commence at least one document processing operation on the document processing device.

2. The system of claim 1 wherein the document processing device includes a scanner, and wherein the document processing operation includes a scan operation via the scanner.

3. The system of claim 2 further comprising a network data storage in network data communication with the document processing device, and wherein the scanner is operable to generate an electronic document from a tangible document, and the document processing device is further operable to communicate the electronic document via a data network from the document processing device to the network data storage.

4. The system of claim 3 wherein:
the document processing device includes a printer and a network interface operable to retrieve the electronic document from the network data storage; and
the document processing operation includes a print operation via the printer of the electronic document retrieved from the network data storage.

5. The system of claim 4 wherein the software interface is operable via a web browser installed on the mobile data device.

6. The system of claim 5 wherein the software interface is operable over an executable application loaded on the mobile data device from the document processing device via the wireless data connector.

7. The system of claim 4 further comprising:
a compatibility tester operable to test a compatibility of the electronic document relative to the printer prior to retrieval thereof from the network data storage; and
an alert generator operable to generate an alert output on the mobile data device in accordance with an output of the compatibility tester.

8. A document processing method comprising:
establishing a wireless data connection between a document processing device including a processor and associated data storage and an associated mobile data device;
initiating a remote installation of a software interface for the document processing device on the mobile data device via the wireless data connection;
receiving a multicast probe via the wireless data connection from the mobile data device initiated in accordance with operation of the software interface after installation thereon;
registering the mobile data device with the document processing device in accordance with a response to the multicast probe; and
receiving from the mobile data device, via the wireless data connection, control data generated by the software interface operable to commence at least one document processing operation on the document processing device.

9. The method of claim 8 further comprising scanning a tangible document to generate electronic document data corresponding thereto.

10. The method of claim 9 further comprising communicating the electronic document via a data network from the document processing device to the network data storage.

11. The method of claim 10 further comprising:
retrieving the electronic document from the network data storage; and
printing the electronic document retrieved from the network data storage.

12. The method of claim 11 wherein initiating a remote installation includes loading for generating a display on the mobile data device via a web browser installed.

13. The method of claim 12 further comprising loading an executable application on the mobile data device from the document processing device via the wireless data connector, and wherein initiating a remote installation includes loading the executable application on the mobile data device.

14. The method of claim 11 further comprising:
testing a compatibility of the electronic document relative to the printer prior to retrieval thereof from the network data storage; and
generating an alert output on the mobile data device in accordance with the compatibility test.

15. A document processing system comprising:
means adapted for establishing a wireless data connection between a document processing device including a processor and associated data storage and an associated mobile data device;
means adapted for initiating a remote installation of a software interface for the document processing device on the mobile data device via the wireless data connection;
means adapted for receiving a multicast probe via the wireless data connection from the mobile data device initiated in accordance with operation of the software interface after installation thereon;
means adapted for registering the mobile data device with the document processing device in accordance with a response to the multicast probe; and
means adapted for receiving from the mobile data device, via the wireless data connection, control data generated by the software interface operable to commence at least one document processing operation on the document processing device.

16. The system of claim 15 further comprising means adapted for scanning a tangible document to generate electronic document data corresponding thereto.

17. The system of claim 16 further comprising means adapted for communicating the electronic document via a data network from the document processing device to the network data storage.

18. The system of claim 17 further comprising:
means adapted for retrieving the electronic document from the network data storage; and
means adapted for printing the electronic document retrieved from the network data storage.

19. The system of claim 18 wherein the means adapted for initiating a remote installation includes means adapted for loading for generating a display on the mobile data device via a web browser installed.

20. The system of claim 19 further comprising mean adapted for loading an executable application on the mobile data device from the document processing device via the wireless data connector, and wherein the means adapted for initiating a remote installation includes means adapted for loading the executable application on the mobile data device.

21. The system of claim 18 further comprising:
means adapted for testing a compatibility of the electronic document relative to the printer prior to retrieval thereof from the network data storage; and
means adapted for generating an alert output on the mobile data device in accordance with the compatibility test.
